(19) United States
(12) Patent Application Publication
(10) Pub. No.: US 2026/0307892 A1
(43) Pub. Date: Oct. 8, 2026

(54) RECLOSABLE CAPSULE FOR PREPARING A BEVERAGE

(71) Applicant: Nootrie AG, Zizers (CH)

(72) Inventors: Cédric SANTANA-SIEGENTHALER, Weesen (CH); Marcel Wilhelm HÜPPI, Rorschacherberg (CH)

(21) Appl. No.: 19/485,259

(22) PCT Filed: May 17, 2023
(86) PCT No.: PCT/EP2023/063390

§ 371 Date: Nov. 17, 2025

(51) Int. Cl. B65D 85/804; A47J 31/40

(52) U.S. Cl. CPC B65D 85/8046; A47J 31/407

(57) ABSTRACT

The invention relates to a capsule for preparing a beverage. The capsule comprises a capsule body enclosing a first chamber for containing a powder and a second chamber having an outlet Further, the capsule comprises a top membrane covering a lid opening of the capsule body at the first chamber and an inner membrane between the first chamber and the second chamber. A closing insert is arranged in the second chamber and an agitator is arranged in the first chamber for agitating the powder. The closing insert is reversibly deformable to transition between a closed state and an open state, wherein the closing insert is configured to close the outlet in the closed state, and to open the outlet in the open state. Further, the invention also relates to a method and an apparatus for preparing a beverage using such capsule.

### TECHNICAL FIELD

The present invention relates to a capsule for preparing a beverage. Further aspects of the invention concern an apparatus and a method for preparing a beverage using the capsule.

### Background Art

Using a capsule with a powder and a corresponding apparatus for injecting a liquid, e.g. water, into the capsule is a convenient and time-saving way for preparing a beverage, such as a sports drink, an energy drink, a soup, or a baby formula. A particularly advantageous capsule with an interior agitator, e.g. for cases in which the powder needs to be homogeneously dissolved in water, has been proposed in EP3536637A1.

A disadvantage of such conventional capsules is that the flow of liquid and dissolved powder from the outlet of the capsule does not stop at once, but will typically continue to drip. If the user removes the glass or cup with the prepared beverage or removes the capsule from the apparatus, this leads to spilling and contamina-tion of the apparatus and its surroundings, e.g. the user's kitchen. These effects reduce the overall user experience and are, thus, undesirable.

### DISCLOSURE OF THE INVENTION

The problem to be solved by the present invention is therefore to provide a capsule, an apparatus and/or a method for preparing a beverage which overcomes the above disadvantages and in particular allows a simple and clean handling and a good user experience.

In a first aspect of the invention, this problem is solved by a capsule for preparing a beverage. The beverage may e.g. be a drink, a refreshing drink, a sports drink, an energy drink, a dietary supplement, a soup, or a baby formula. The capsule comprises the following components:
a capsule body which encloses a first chamber for containing a powder and a second chamber having an outlet: In particular, the beverage, when ready, leaves the capsule through the outlet and is transferred to a glass or cup, advantageously through the action of gravity and/or by injection of liquid and/or air in the capsule. In an operation position, the outlet is advanta-geously arranged at a lower side or bottom side of the capsule. In an embodiment, the powder is soluble in a liquid, e.g. in water.
a top membrane covering a lid opening of the capsule body at the first chamber: In the operation position, the lid opening is advantageously arranged at the upper side or top side of the capsule. Advanta-geously, the capsule body has an upper rim, e.g. a circumferential rim around the lid opening.
an inner membrane between the first chamber and the second chamber: In particular, the first chamber is configured to enclose the powder and protect it from detrimental influences such as humidity. In other words, the capsule body, the top membrane and the inner membrane are advantageously impermeable and in particular gas and water tight.
a closing insert arranged in the second chamber: The closing insert is reversibly deformable to transition between a closed state and an open state. Reversibly deformable shall in particular mean that the closing insert is configured to resume its original shape, at least to a large extent, by the action of elasticity after a deformation through an external force. In other words, the closing insert is in particular elas-tically deformable. Further, the closing insert is configured to close the outlet in the closed state, and to open the outlet in the open state.
an agitator arranged in the first chamber for agitating the powder: In particular, the agitator is configured to mix the powder e.g. with any injected liquid in the first chamber upon rotation of the agitator.

Such capsule solves the above problem since the closing insert automatically recloses the outlet after preparing the beverage. This avoids any spilling of left-over beverage from the capsule and, thus, any con-tamination of the apparatus holding the capsule for preparing the beverage or of the environment of the apparatus. In other words, such capsule provides a good user experience since it is simple to handle and quick for preparing the beverage. In particular, there is no need to wait until the last drop has dripped from the capsule before the ready beverage can be taken from the apparatus.

In an advantageous embodiment, e.g. comprising a rotationally symmetric capsule body, the closing insert is configured to transition from the closed state to the open state upon application of an axial force. In particular, the axial force may be directed towards the outlet, and/or the axial force may act on a central plug of the closing insert. This allows to manipulate the closing insert, e.g. via a force element of the apparatus, for opening the outlet either from the top side or from the bottom side of the capsule.

Advantageously, the closing insert is configured to transition from the open state to the closed state through elasticity upon removal of the axial force.

### Agitator

In an embodiment, the agitator comprises a central shaft, a blade attached to the central shaft and a bearing pin arranged in extension of the central shaft. The bearing pin is in effective connection with the closing insert. In particular, the effective connection shall mean that the bearing pin is in force closure with the closing insert. Advantageously, only the inner membrane is arranged between and in contact with the bearing pin and the closing insert. This allows to act on the closing insert by axially shifting the agitator, in particular through an external force on the central shaft.

In a particular embodiment, the bearing pin is pivoted in a recess of the closing insert, again advantageously with the inner membrane in between the bearing pin and the closing insert. Such recess provides a bearing for the bearing pin, in particular when the agitator is rotated.

Advantageously, the inner membrane is attached to the closing insert, e.g. by gluing or heat-sealing. The inner membrane may be attached to the recess of the closing insert. On the one hand, this forms a better mounting for the bearing pin of the agitator. On the other hand, this fixates the inner membrane, in particular its inner part, after being cut by at least one stud of the agitator.

In a further embodiment, the agitator comprises at least one stud for piercing and/or cutting the inner membrane. Advantageously, the at least one stud is arranged at a bottom part of the blade. Piercing and/or cutting the inner membrane may in particular be effected by an axial and/or a circumferential motion of the agitator. An exemplary method including such piercing and/or cutting the inner membrane is described in EP3536637A1 whose disclosure is incorporated herein by reference.

The capsule further advantageously comprises a top bearing element for the shaft of the agitator. The top bearing element is arranged at the lid opening, e. g. as an insert in the lid opening. The shaft of the agitator is mounted pivotable and axially shiftable in the top bearing element. The top bearing element supports the agitator during shifting, in particular for cutting/piercing the inner membrane and opening the outlet, and during rotation, in particular for mixing the powder and cutting/piercing the inner membrane.

In an embodiment, the top membrane provides a sealing, in particular via heat-sealing or gluing, at an edge of the lid opening and at the top bearing element.

In this way, the top membrane is kept in place and the first chamber is kept sealed when the force element engages with the shaft of the agitator and when at least one injection needle of the apparatus pierces the top membrane. This avoids spilling of beverage and contamination of the apparatus.

### Capsule and Material

In an embodiment, the capsule body has a rotationally symmetric shape. In particular, the shape may be essentially frustoconical. This simplifies the han-dling of the capsule, in particular inserting in and removing from a capsule holder of the corresponding apparatus.

Further, the first chamber may be configured to contain at least 10 g of powder and in particular 20 to 35 g of powder for preparing the beverage.

Advantageously, one or more of the capsule body, the agitator, the closing insert, and the top bearing element are made of plastic, bioplastic or of a compostable material. In particular, one or more of these components, advantageously all of these components, are made of a polylactide or a polyhydroxyalkanoate. This makes the entire capsule not only recyclable but also compostable. Alternatively, the closing insert may be made of polypropylene.

As described above, the inner membrane and/or the top membrane are advantageously impermeable to liquid and gas. In particular, they may comprise a plastic film, in particular a compostable plastic film, or an aluminium film.

### Closing Insert

In an embodiment, the closing insert comprises a central plug configured to seal the outlet in the closed state. Advantageously, in the closed state, the central plug is flush with an outlet wall of the capsule body. In particular, a contact surface between the central plug and the outlet wall may be cylindrical. This allows an unrestricted axial sliding of the central plug within the outlet wall. Further, the contact surface, in the closed state, advantageously extends over at least 1 mm in the axial direction. This ensures a liquid tight closure of the outlet in the closed position, in particular supported by surface tension of the liquid.

In an embodiment, the closing insert comprises support elements bearing on a bottom wall of the capsule body. Advantageously, the support elements are connected to the central plug via one or more flexible arms, in particular at least two or three flexible arms. In other words, the flexible arms may provide the elasticity to the closing insert for the reversible deformation that is required for the transition between closed state and open state and vice versa. In a particular embodiment, the flexible arms may take a spiralling shape between the central plug and the support elements.

In a further embodiment, an outer edge of the closing insert is continuous. In other words, the flexible arms may be interconnected at their distal ends. Such compact design of the closing insert is advantageous for the production of the closing insert and the assembly of the capsule since the closing inserts cannot entangle with each other or with other components of the capsule. In an advantageous embodiment, the capsule body is stiffer than the closing insert, in particular by at least a factor of 3. This may be achieved by a different thickness or structure of the two components and/or by different elastic moduli of the two components. It ensures that, when a force is acting on the closing insert, the closing insert is deformed, while the capsule body essentially maintains its original shape. In the embodiment with flexible arms, this means that the bottom wall of the capsule body is stiffer than the one or more flexible arms of the closing insert.

In an embodiment, the central plug comprises one or more flow channels configured to let the beverage exit from the capsule in the open state. In particular, the flow channels may be formed by recesses in or holes through the central plug. Advantageously, the flow channels are shaped and/or oriented such that they impose a specific direction or type of flow on the beverage exiting the capsule. For a clean operation and good user experience, it is advantageous that a laminar flow and/or a convergent flow, in particular a single laminar jet, are imposed on the beverage exiting the capsule. In this way, the beverage leaves the outlet as one continuous stream in a defined direction towards or into a glass or cup.

In an embodiment, a continuous and directed stream of beverage from the capsule is achieved in that the central plug comprises a tapered, e.g. conical, outer surface facing an exterior of the capsule. In particular, the outer surface of the central plug may exhibit a 3-fold, 4-fold or 5-fold rotational symmetry. Such shapes of the central plug improve the laminarity of the flow.

In an embodiment, the outlet comprises an inner wall which is converging towards the exterior of the capsule. In other words, a cross-section of the outlet may be decreasing towards the exterior. This, again, leads to a converging and laminar flow of the beverage.

Advantageously, the inner wall of the outlet comprises an undercut. This facilitates a smooth flow separation from the outlet and, thus again, a single laminar flow of beverage from the capsule.

### Method

A second aspect of the invention relates to a method for preparing a beverage using the above capsule. The method comprises the following steps:
injecting water in the first chamber: Depending on the beverage to be prepared, the water may have room temperature, be heated or cooled. Advanta-geously, the water is injected in the first chamber through at least one injection needle attached to an apparatus for preparing the beverage as described below.

The at least one injection needle is configured to pierce the top membrane of the capsule and inject water in the first chamber.
mixing the powder and the water in the first chamber while the inner membrane is intact and the closing insert is in the closed state: The mixing may in include rotating the agitator, in particular through the motion of a motor of the apparatus that may be transferred to the shaft of the agitator via a force element attached to the motor.
piercing and/or cutting the inner membrane: This may comprise axially shifting the agitator towards the outlet and in particular rotating the agitator. In particular, the inner membrane may be pierced and/or cut by the stud of the agitator as mentioned before. Axially shifting and rotating the agitator may both be effected through the force element of the apparatus.
deforming the closing insert from the closed state to the open state: This may include applying an axial force on the closing insert. In particular, the step of deforming may be performed simultaneously with the step of piercing and/or cutting the inner membrane, e.g. through the axial shift of the agitator. Accordingly, deforming the closing insert may also comprise axially shifting the agitator towards the outlet.
letting the closing insert relax to the closed state: In an embodiment, this may include axially shifting the agitator towards the lid opening. In this way, the axial force on the closing insert is removed, and the closing insert relaxes to the closed state by the action of elasticity.

In an embodiment, the method further comprises a venting step, advantageously simultaneously with the step of injecting water in the first chamber. Venting in particular includes letting excess gas, in particular air, vent from the first chamber through a venting opening, e.g. in the top membrane. The venting opening may be formed by a venting needle of the apparatus configured to pierce the top membrane, in particular simultaneously with the at least one injection needle, and to let gas vent from the first chamber. The venting step prevents any overpressure building up in the capsule and, thus, any potential damage to the capsule or spilling of the capsule, in particular while injecting water.

In a further embodiment, the method further comprises a step of, at least partly, blowing out remaining beverage from the capsule still in the open state before letting the closing insert relax to the closed state. Blowing out remaining beverage in particular includes injecting gas, e.g. air, in the first chamber, advantageously through the at least one injection needle.

Additionally gas may also be injected through the venting needle if present. The step of blowing out facilitates a sufficient emptying of the capsule. In particular, it ensures a high yield of beverage from the powder contained in the capsule. Further, it avoids an excessive weight of the empty capsule which may then be recycled or composted.

### Apparatus

A third aspect of the invention relates to an apparatus for preparing a beverage. The apparatus comprises
a capsule holder configured to receive the capsule described above: Advantageously, the capsule holder is configured to hold the capsule, e.g. after sliding the capsule into the capsule holder, at the upper rim of the capsule.
a water supply configured to supply water to the capsule: The water supply comprises an injection needle configured to pierce the top membrane and to supply water into the first chamber of the capsule. The water supply advantageously comprises a pump configured to pump water through the injection needle. Advantageously, the pump is a membrane pump. Such pump is able to pump both water, e.g. in the injecting step, and gas/air, e.g. in the blowing out step.
a motor configured to drive the agitator of the capsule: The motor may be attached to a force element configured to engage with agitator, in particular with the shaft of the agitator.
an actuator, e.g. a second motor, configured to shift the force element for deforming the closing insert from the closed state to the open state: In an embodiment, the force element is configured to engage with the shaft of the agitator and to apply an axial force on the closing insert via the bearing pin of the agitator.
a control unit in communication with the water supply, the motor and the actuator and configured to perform the method described above.

The features disclosed with respect to one of the aspects of the invention are meant to be also disclosed with respect to the other aspects of the invention. Other advantageous embodiments are listed in the dependent claims as well as in the description below.

### BRIEF DESCRIPTION OF THE DRAWINGS

The invention will be better understood and objects other than those set forth above will become ap-parent from the following detailed description thereof.

Such description makes reference to the annexed drawings, wherein:

FIG. 1 shows an exploded view of a capsule according to an embodiment of the invention;

FIGS. 2 and 3 show vertical cuts through the capsule of FIG. 1 in the closed state and the open state, respectively, as well as a detailed view of the lower part of the capsule in the two states.

### MODES FOR CARRYING OUT THE INVENTION

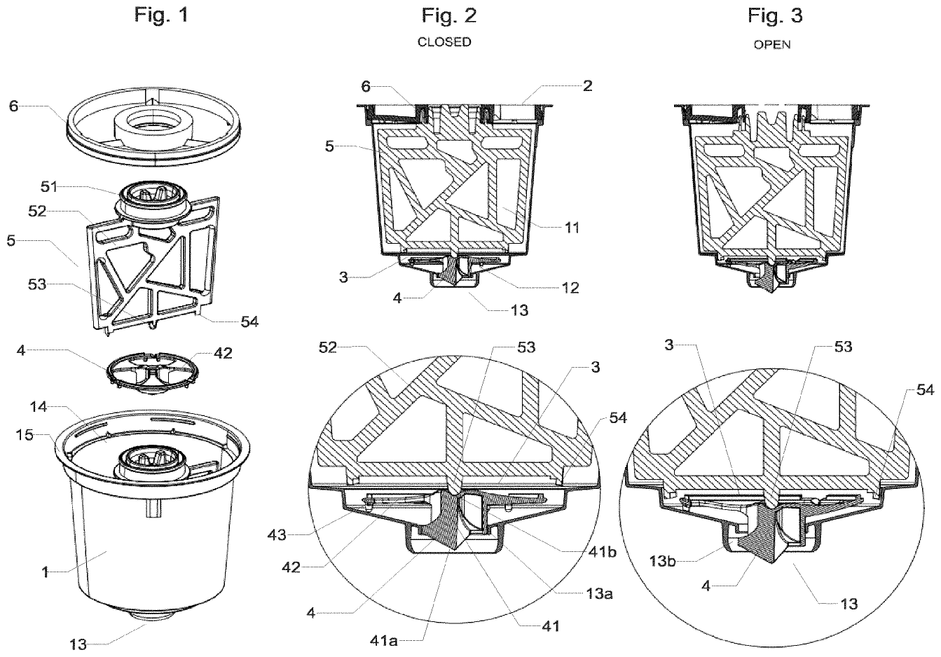

FIG. 1 illustrates various components of an embodiment of the capsule which can be used with the above method and/or apparatus for preparing a beverage. The capsule body 1 is hollow and has an essentially frustoconical shape. The capsule body 1 has a lid opening 14 which, after filling of the capsule with powder is closed by the top membrane 2 (not shown in FIG. 1, see FIG. 2). Further, the capsule body 1 advantageously has an upper rim 15 around the lid opening 14 for opening the capsule, e.g. in the apparatus. The capsule body 1 encloses the first chamber 11 with the powder and the second chamber 12 with the outlet 13. The first and the second chamber are separated by the inner membrane 3, see again FIG. 2.

The agitator 5 is arranged in the first chamber 11. The agitator 5 comprises a central shaft 51 for engaging with a force element of the concerning apparatus. Advantageously, the central shaft 51 comprises protrusions and recesses configured to engage with a complementary surface of the force element. The central shaft 51 is mounted in the top bearing insert 6 such that the agitator 5 may be shifted axially, i.e. vertically in FIGS. 1 to 3. Advantageously, central shaft 51 is mounted to the top bearing insert 6 in a sealed way such that liquid cannot leave the first chamber 11 between the central shaft 51 and its mounting in the top bearing insert 6. This may e.g. achieved by a protrusion at the central shaft and a corresponding recess at the top bearing insert 6 or by a labyrinth-type entanglement between the central shaft 51 and its mounting.

The agitator 5 further comprises at least one blade 52. In the embodiment of FIGS. 1 to 3, the blade 52 is not continuous but has a lattice structure. This supports a smooth rotation and good mixing of the powder. Arranged centrally at the bottom part of the agitator 5, there is a bearing pin 53. The bearing pin 53 is, in general, configured to guide the agitator 5 during rotation and advantageously to transfer an axial force acting on the agitator 5 on the closing insert 4. Further, the agitator 5 comprises at least one stud 54, here two studs, for piercing/cutting the inner membrane 3.

FIG. 2 shows the capsule in the closed state, i.e. with the outlet 13 closed by the closing insert 4. When the capsule is filled with powder and delivered to the user, it is in the closed state. In such state, the powder is enclosed in the first chamber 11 by the capsule body 1, the top membrane 2 and the inner membrane 3. In this way, the powder is protected against detrimental effects e.g. of humidity.

The detailed view in the lower part of FIG. 2 shows the closing insert 4 in detail as well as the effective connection between the agitator 5 and the closing insert 4: The bearing pin 53 of the agitator 5 is mounted in a recess 41b of the central plug 41 of the closing insert 4. Only the inner membrane 3 is interlaying between the bearing pin 53 and the central plug 41 for enclosing the powder in the first chamber 11. The recess 41b serves as a mount to guide the agitator 5 during rotation.

In the closed state, the at least one stud 54 of the agitator 5 abuts on but does not cut or pierce the inner membrane 3.

The central plug 41 of the closing insert 4 comprises a cylindrical part which, in the closed state, abuts on a complementary inner cylindrical wall 13a of the capsule body 1 for closing the outlet 13. Advantageously, the central plug 41 has a tapered outer surface 41a which supports the forming of a laminar stream of beverage at the outlet 13 when the capsule is in the open state (FIG. 3). Advantageously, the forming of a single laminar stream is further supported by the inner wall 13b of the outlet 13 converging towards the exterior. The inner wall 13b may additionally exhibit an undercut as shown in FIG. 3 for facilitating a better flow separation from the outlet 13.

The closing insert 4 further comprises support elements 43 for supporting and holding the closing insert 4 in place in the second chamber 12. The support elements 43 may take the form of protrusions, e.g. resting on a bottom wall of the capsule body 1 or arranged in corresponding recesses in the bottom wall. The support elements 43 are in connection with the central plug 41 via flexible arms 42. The flexible arms 42 are configured to hold the central plug 41 in place and guide it during an axial shift, in particular when transiting to the open state. Further, the flexible arms 42 form an elastic element, in other words a spring, for reclosing the outlet when the axial force on the central plug 41 is removed.

FIG. 3 shows the capsule in the open state, i.e. with the outlet 13 open such that the beverage can exit the capsule. The transition between the closed state of FIG. 2 and the open state of FIG. 3 is achieved by an axial shifting of the agitator 5 towards the outlet 13. Advantageously, such shifting is effected by an axial force on the central shaft 51 of the agitator 5. The axial force, through the stiffness of the agitator 5, then acts on the central plug 41 of the closing insert 4 and shifts it towards the outlet 13, thereby opening the outlet.

At the same time, the axial shift of the agitator 5 leads to a piercing/cutting of the inner membrane 3 by the at least one stud 54. In this way, a connection between the first chamber 11 and the second chamber 12 is formed such that the beverage may flow from the first chamber 11 through the second chamber 12 towards the outlet 13. The effect of piercing/cutting the inner membrane 3 may advantageously be improved by a simultane-ous or subsequent rotation of the agitator 5.

After the capsule is emptied in the open state, in particular after the above described step of blowing out the capsule, the axial force on the agitator 5 is removed or, advantageously, the agitator 5 is ac-tively shifted axially back towards the lid opening 14. As described before, the closing insert 4 will then relax to its original state, thereby closing the outlet 13 and bringing the capsule in the closed state.

Such reclosable capsule avoids after-dripping of beverage from the outlet and spilling of remaining beverage from the capsule. Therefore, it is simple and quick to use and leads to a positive user experience.

1. A capsule for preparing a beverage, comprising
a capsule body enclosing a first chamber for containing a powder and a second chamber having an outlet,
a top membrane covering a lid opening of the capsule body at the first chamber,
an inner membrane between the first chamber and the second chamber
a closing insert arranged in the second chamber,
an agitator arranged in the first chamber for agitating the powder,
wherein the closing insert is reversibly deformable to transition between a closed state and an open state, wherein the closing insert is configured to close the outlet in the closed state, and to open the outlet in the open state.

2. The capsule of claim 1,
wherein the closing insert is configured to transition from the closed state to the open state upon application of an axial force, in particular an axial force towards the outlet and/or in particular an axial force on a central plug of the closing insert
in particular wherein the closing insert is configured to transition from the open state to the closed state through elasticity upon removal of the axial force.

3. (canceled)

4. The capsule of claim 1,
wherein the agitator comprises a central shaft a blade attached to the central shaft and a bearing pin arranged in extension of the central shaft,
wherein the bearing pin is in effective connection with the closing insert,
in particular wherein the bearing pin is pivoted in a recess of the closing insert, and
in particular wherein the inner membrane is attached to the closing insert at the recess.

5. The capsule of claim 1,
wherein the agitator comprises at least one stud for piercing and/or cutting the inner membrane in particular upon an axial and/or a circumferential motion of the agitator

6. The capsule of claim 4 further comprising
a top bearing element for the shaft of the agitator arranged at the lid opening,
wherein the shaft is mounted pivotable and axially shiftable in the top bearing element,
in particular wherein the shaft is mounted in the top bearing element in a liquid-tight manner, and/or
in particular wherein the top membrane provides a sealing at an edge of the lid opening and at the top bearing element.

7. (canceled)

8. The capsule of claim 1,
wherein the capsule body has a rotationally symmetric, in particular an essentially frustoconical, shape.

9. The capsule of claim 1,
wherein the first chamber is configured to contain at least 10 g of powder for preparing the beverage,
in particular 20 to 35 g of powder.

10. The capsule of claim 1,
wherein one or more of the capsule body, the agitator, the closing insert, and the top bearing element are made of plastic, bioplastic or of a compostable material, in particular of a polylactide or a polyhydroxyalkanoate,
in particular wherein the closing insert is made of polypropylene.

11. The capsule of claim 1,
wherein the inner membrane and/or the top membrane comprise a plastic film or a bioplastic film.

12. The capsule of claim 1,
wherein the closing insert comprises a central plug configured to seal the outlet in the closed state
in particular wherein, in the closed state, the central plug fold is flush with an outlet wall of the capsule body, and
in particular wherein a contact surface between the central plug fold and the outlet wall is cylindrical and in particular extends over at least 1 mm in the axial direction.

13. (canceled)

14. The capsule of claim 1,
wherein the closing insert comprises support elements bearing on a bottom wall of the capsule body,
in particular wherein the support elements are connected to the central plug via one or more flexible arms, in particular at least two or three flexible arms.

15. The capsule of claim 1,
wherein the capsule body is stiffer than the closing insert in particular by at least a factor of 3,
in particular wherein the bottom wall of the capsule body is stiffer than the one or more flexible arms of the closing insert

16. The capsule of claim 12,
wherein the central plug comprises one or more flow channels configured to let the beverage exit from the capsule in the open state,
in particular wherein the flow channels are formed by recesses in or holes through the central plug
and/or
in particular wherein the flow channels are shaped and/or oriented such that they impose a laminar flow and/or a convergent flow on the beverage exiting the capsule.

17. (canceled)

18. The capsule of claim 12,
wherein the central plug comprises a tapered outer surface facing an exterior of the capsule, in particular exhibiting a 3-fold, 4-fold or 5-fold rotational symmetry.

19. The capsule of claim 1,
wherein the outlet comprises an inner wall which is converging towards the exterior of the capsule,
in particular wherein the inner wall of the outlet comprises an undercut.

20. A method for preparing a beverage using the capsule of claim 1, comprising steps of
injecting water in the first chamber,
mixing the powder and the water in the first chamber, in particular by rotating the agitator, while the inner membrane is intact and while the closing insert is in the closed state,
piercing and/or cutting the inner membrane and, in particular simultaneously,
deforming the closing insert from the closed state to the open state, in particular by applying an axial force on the closing insert,
letting the closing insert rela to the closed state.

21. The method of claim 20 using the capsule of claim 1,
wherein piercing and/or cutting the inner membrane comprises axially shifting the agitator towards the outlet and in particular rotating the agitator.

22. The method of claim 20 tousing the capsule of claim 1,
wherein deforming the closing insert comprises axially shifting the agitator towards the outlet,
wherein letting the closing insert relax to the closed state comprises axially shifting the agitator towards the lid opening.

23. An apparatus for preparing a beverage, comprising
a capsule holder configured to receive the capsule of claim 1,
a water supply configured to supply water to the capsule, wherein the water supply comprises an injection needle configured to pierce the top membrane and to supply water into the first chamber of the capsule,
a motor configured to drive the agitator of the capsule,
an actuator configured to shift a force element for deforming the closing insert from the closed state to the open state,
a control unit in communication with the water supply, the motor and the actuator, and configured to perform the method of claim 16.

24. The apparatus of claim 23, wherein the force element is configured to engage with the shaft of the agitator and to apply an axial force on the closing insert via the bearing pin of the agitator.
